(19) United States
(12) Patent Application Publication
(10) Pub. No.: US 2009/0225973 A1
(43) Pub. Date: Sep. 10, 2009

(54) METHOD FOR FORWARDING A REQUEST OF CONNECTION AS WELL AS TELECOMMUNICATION SYSTEM

(75) Inventor: Martin Fischer, Niederhausen (DE)

Correspondence Address: SHERIDAN ROSS P.C., 1560 BROADWAY, SUITE 1200, DENVER, CO, 80202, US

(73) Assignee: AVAYA GMBH & CO. KG, Frankfurt am Main (DE)

(21) Appl. No.: 12/043,761

(22) Filed: Mar. 6, 2008

(51) Int. Cl. H04M 3/42

(52) U.S. Cl. 379/211.02

(57) ABSTRACT

A method for forwarding a request of connection originating from a first telecommunication apparatus (6) allocated to a calling subscriber from a second telecommunication apparatus (6) allocated to a called but absent subscriber to a third telecommunication apparatus (6) shall take into account the interests of the calling subscriber in a particularly great extent. For this purpose, the calling subscriber is offered, according to the invention, to select the third telecommunication apparatus (6).

### FIELD

The invention relates to a method for forwarding a request of connection originating from a first telecommunication apparatus allocated to a called but absent subscriber to a third telecommunication apparatus. It also relates to a telecommunication system for carrying out the method.

### BACKGROUND

Such concepts of forwarding a call for the case that a called subscriber is not available at his telecommunication apparatus and, therefore, cannot answer the request of connection triggered by an incoming call, are vary common, especially in large telecommunication installations or telecommunication networks. Often, an automatic call forwarding or call diversion device is used, in which a subscriber stores a fixed call number of another telecommunication apparatus to which the incoming calls will be forwarded if, temporarily or also for a longer period, he cannot be reached at his working place or by means of the telecommunication apparatus assigned to it. Instead, such an automatic call forwarding can also be forwarded to an answering machine which will, if desired by the calling party, record a voice message for the subscriber who is not available at the moment.

Alternatively or in addition to such automatic or unconditioned call forwarding devices, so-called conditioned call forwarding devices can also be used, in which a request of connection incoming for a telecommunication apparatus is forwarded to an alternative telecommunication device, if a specified condition is given. This may be, for example, a call forwarding for the case that the called telecommunication apparatus is engaged at the moment. For such cases, the users of the called telecommunication apparatuses usually fixedly store a number to which incoming calls shall in such cases be forwarded. Such a concept is possible in particular also for mobile telephone terminals in which the forwarding of an incoming call, for example to an answering machine, can also be provided and adjusted for the case that a user of the mobile telephone terminal is not accessible for lack of connection through the mobile communication network or for other reasons, or for the case that he has switched off his mobile telephone.

In such systems, the calling party is, therefore, always in the situation that, if the desired subscriber is not accessible or not available, he will be connected with an answering machine system or with a fixedly preset alternative device. Especially in telecommunication installations in large organizations, for example authorities, big enterprises or the like, this might, however, be inappropriate and not in accordance with the interests. Especially in such relatively large organizations, which are equipped with a telecommunication system with a multitude of terminals, it is imaginable that the calling party does not want to speak with the originally called subscriber because of the latter's person or because of a personal relationship, but rather concerning a question of fact, a subject-matter responsibility or a subject-matter competence. Should the called subscriber not be available at the moment, it is in such a case possible that the calling party terminates the request of connection and tries with a new call to reach another contact person with the same or a similar competence in the matter. This requires, however, that the calling party possesses sufficient information about the structure of the called organization, authority or company to select a suitable alternative contact person. This information is usually not available to the calling party, especially in the case of large organizations.

### SUMMARY

Therefore, the invention is based on the problem to provide a method of call forwarding of the above-described type, which is able to take into account the interests of the calling subscriber to a particularly great extent. Furthermore, a telecommunication system shall be provided which is particularly suitable for carrying out the method.

Regarding the method, this problem is solved according to the invention by offering the calling subscriber for the case that the originally selected and called subscriber is not available or not accessible, a possibility to select the third telecommunication apparatus to which the request of connection shall be forwarded.

The invention is based on the knowledge that especially in case of a subject-related request or the like of the calling subscriber, where not the person of the originally called subscriber, but rather his subject-matter competence, spatial positioning or the like is of importance, the calling party should be forwarded, as a function of his interests, to other persons, who are related with the originally called subscriber concerning their subject-matter competence, spatial positioning or the like. In view of the fact that the calling party usually does not possess information on such persons, who would be in a position, due to their subject-matter competence or also due to other criteria, to process the request of the calling party instead of the originally selected person, the calling party should first of all be informed of the available possibilities of call forwarding, taking into account the interests of the calling party. On this basis, a call forwarding in compliance with the interests is made possible by granting the calling party the possibility to give specifications for the call forwarding based on such information.

For a structured and purposeful processing of the selection of a suitable call forwarding, the calling party is advantageously offered first of all a number of criteria or categories from which he can choose one, in the manner of a selection. These criteria or categories can be, for example, information on the subject-matter competence of the respective subscriber, organization-related information, such as, for example, the indication of the designation of an internal division, or also indications of location, such as, for example, sites, rooms in a building or storeys. It can, for example, also be assumed that due to the employment of the subscriber in question in the same division or organizational structure as the originally called subscriber or else due to the proximity of the workplace of the subscriber in question to the workplace of the originally called subscriber it can be concluded that accordingly the respective subscriber will also have a similar subject-matter competence. Alternatively or additionally, it can, for example, also be concluded that due to the close proximity of the workplaces of the subscribers, the subscriber to whom the call is forwarded might be able to give more detailed information on the future availability of the originally called subscriber.

To make the selection of the third communication apparatus particularly effective, keeping the expenditure relatively low, suitable communication means from the technical point of view are advantageously used for the communication exchange with the calling party. In a particularly advantageous embodiment, the selection is screen-operated, preferably in the manner of a menu selection by means of an allocated computer unit, whereby, as a basis of the selection of the third communication apparatus, a screen information is advantageously transmitted to the first telecommunication apparatus. Alternatively or additionally, a voice-operated data exchange can be effected to support the communication with the calling party, a number of voice messages being advantageously transmitted to the first telecommunication apparatus for the selection of the third telecommunication apparatus.

Especially by using such communication technologies, a particularly purposeful selection of a suitable third telecommunication apparatus for the calling party is made possible in a particularly simple way by a menu-driven selection of the third telecommunication apparatus. The calling party can in particular be offered first of all a number of options, in the manner of hierarchically graded categories, which, starting from relatively general categories, become more and more detailed, until finally relatively concretely delimitable workplaces or persons are directly offered for selection.

With regard to the telecommunication system with a number of telecommunication apparatuses connected to a central exchange equipment, the above-mentioned problem is solved by providing the exchange equipment with an exchange interface designed for carrying out the above-mentioned method for incoming requests of connection. Advantageously, all incoming calls, both external and internal ones, i.e. from subscribers inside the telecommunication system, are handled via this exchange interface. Advantageously, the exchange interface is connected on the data side to a central database in which, in a way depending on the category, identifiers of the connected telecommunication apparatuses are stored. For a caller-operated navigation, the exchange interface can then specifically query such categories and any individual data records or sub-categories linked with them and offer them to the calling party for selection.

The advantages achieved with the invention consist in particular in the fact that to the election, which can be influenced by the calling party, of a suitable terminal to which the call shall be forwarded, the specific interests of the calling party can be taken into consideration in the call forwarding in a particularly efficient and flexible manner. Contrary to known systems, in which the terminal to which in case of doubt an incoming call shall be forwarded, is determined and selected exclusively by the user of the called terminal, the system according to the invention offers the possibility to take the calling party's interests into consideration in a particularly efficient way upon the exchange and connection setup already.

### BRIEF DESCRIPTION OF THE DRAWING

FIG. 1 is a block diagram of a communication system in accordance with embodiments of the present invention.

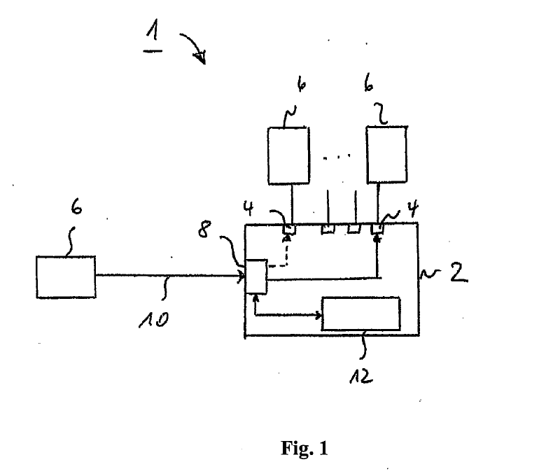

### DETAILED DESCRIPTION

An exemplary embodiment of the invention is explained in detail by means of a drawing, in which the figure is a diagrammatic view of a telecommunication system.

The telecommunication system 1 according to the figure comprises a central exchange equipment 2, to which a number of terminals or telecommunication apparatuses 6 are connected via suitable interfaces 4. The telecommunication system 1 can in particular be a large-scale installation with a multitude of connected telecommunication apparatuses 6, like the ones use, for example, in an authority, a big enterprise or the like.

The exchange equipment 2 comprises among others an integrated exchange interface 8, on which all incoming calls arrive, for example as indicated in the figure by the arrow 10, coming from an external communication device 6 or alternatively also from the internal telecommunication apparatuses 6. The exchange interface 8 designed in such a way for incoming requests of connection determines as a rule by means of incoming characteristic information of the calling party, in particular a selected target telephone number, the telecommunication apparatus 6 corresponding to the request of connection and sets up the connection between the calling telecommunication apparatus 6 and the desired target telecommunication apparatus 6.

The telecommunication system 1 is equipped for any necessary call forwarding for the case that when a request of connection arrives at the exchange interface 8, it is found that the telecommunication apparatus 6 desired as target apparatus is not available at the moment, for example because it is engaged or else because the corresponding user temporarily deactivated or blocked his terminal or identified it in any other way as not being available. In such case, the exchange interface 8 forwards the incoming call and the corresponding request of connection to another one of the telecommunication apparatuses 6. The call forwarding device in the telecommunication system 1 is designed to a particularly high degree for taking into account to a great extent the interests of the calling party in order to offer a particularly high degree of service.

The embodiment of the telecommunication system 1 makes use of the knowledge that a calling party often determined a request of connection with a specifically selected subscriber not because of the latter's person, but because of his qualification for the subject-matter, his function in the organizational structure or the like. Should such a called subscriber not be available, the telecommunication system 1 is designed for setting up a call forwarding operation in such a way that the original interests of the calling party are taken into account to a great extent. For this purpose, the calling party is offered, in case of non-availability of the called subscriber, some possibilities of selection by means of which the calling party can determine or define to which telecommunication apparatus 6 the call shall be forwarded.

In such case, the exchange interface 8 transmits to the telecommunication apparatus 6 from which the call and the request of connection arrived information about the fact that the originally desired connection is at the moment not available, and offers some possibilities of selection concerning the forwarding of the request of connection. The exchange interface 8 transmits first of all a number of categories from which the calling party can select one. These categories can be, for example, division codes of the respective subscriber, other information about the association to individual organizational units, indications of location in view of the proximity to the originally called subscriber, information concerning the qualification in the subject matter and/or other indications which allow the calling party an allocation to certain criteria. By means of these categories, provided for example in the form of a screen information, voice message or any other suitable way in the manner of the menu-driven selection list, the calling party can then make a suitable choice of the possibly eligible contact person.

Afterwards, the request of connection can be forwarded to an already selected body having competence in the subject matter, such as, for example, the secretariat of a division or the like, to another suitable person, for example a colleague or employee of the originally called subscriber, the latter's superior, or to other suitable subscribers. Furthermore, in a possibly following step, the calling party can be offered as a further option a list of names of possibly qualified available contact persons, from which he can select one for the solution of his individual problem. In this case, the exchange interface 8 can directly forward the call to the selected person, i.e. to the latter's telecommunication apparatus 6.

For a suitable provision of the information necessary for the selection, the central exchange equipment 2 includes an integrated central database 12, in which the information about the individual telecommunication apparatuses 6 and the respective users allocated to them is stored in a suitable form, making use of suitories or criteria.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

### LIST OF REFERENCE NUMBERS

1 Telecommunication system
2 Exchange equipment
3 Interfaces
4 Telecommunication apparatuses
8 Exchange
10 Arrow
12 Central database

1. A method, comprising:
forwarding a request for connection originating from a first telecommunication apparatus allocated to a calling subscriber from a second telecommunication apparatus allocated to a called but absent subscriber to a third telecommunication apparatus; and
offering the calling subscriber an opportunity to select the third telecommunication apparatus.

2. The method according to claim 1, wherein the calling subscriber is first of all offered a number of selection categories for the third telecommunication apparatus, from which the calling subscriber can select one category.

3. The method according to claim 1, wherein screen information is transmitted to the first telecommunication apparatus for use in selecting the third telecommunication apparatus.

4. The method according to claim 1, wherein screen information is transmitted to a computer unit allocated to the first telecommunication apparatus for use in selecting the third telecommunication apparatus.

5. The method according to claim 1, wherein a number of voice messages are transmitted to the first telecommunication apparatus for use in selecting the third telecommunication apparatus.

6. The method according to claim 1, wherein the third telecommunication apparatus is selected in a menu-driven manner.

7. A telecommunication system including a number of telecommunication apparatuses which are connected to central exchange equipment, the central exchange equipment including an exchange interface for processing incoming requests for connection, according to claim 1.

8. The telecommunication system according to claim 7, wherein the exchange interface is connected on a data side with a central database, wherein identifiers of the connected telecommunication apparatuses are stored in a way depending on a category.
